(19) United States
(12) Patent Application Publication
(10) Pub. No.: US 2012/0042073 A1
(43) Pub. Date: Feb. 16, 2012

(54) Method and Nodes for Transmitting User Context between Communication Networks

(75) Inventors: Sofie Lassborn, Sollentuna (SE); Christer Boberg, Tungelsta (SE); Mikael Klein, Huddinge (SE); Anders Lindgren, Alvsjo (SE)

(73) Assignee: TELEFONAKTIEBOLAGET LM ERICSSON (PUBL), Stockholm (SE)

(21) Appl. No.: 13/262,375

(22) PCT Filed: Apr. 1, 2009
(86) PCT No.: PCT/SE2009/050345

§ 371 Date: Oct. 31, 2011

(51) Int. Cl. G06F 15/173

(52) U.S. Cl. 709/225

(57) ABSTRACT

A method of managing a subscription request at a originating network node of a first network operator is provided, where a subscription request originating from, or on behalf of a user being a subscriber of the first network operator is provided with user context that is specifying an agreement between the first network operator and the subscriber. The subscription request is then transmitted to a terminating network node of a second network operator, with which the first network operator has established an interoperability agreement. The described procedure enables the second network operator to authorize the subscription request taking the user context into consideration, such that the interoperability agreement between the two network operators is applied for the subscriber also by the second network operator.

### TECHNICAL FIELD

The present invention generally relates to the field of interoperating communication networks, and in particular to transmission of user context between interoperating communication networks of different network operators.

### BACKGROUND

Today there are standards available that facilitate interoperability between different communication networks, thereby enabling network operators that have established an agreement between each other to allow their respective subscribers to access services, not only via the network operators own communication network, but also via the communication network of the other network operator.

FIG. 1 is a simplified illustration according to the prior art which shows two communication networks, between which interoperability can be established. A first communication network 100, being a network of a first network operator, is interconnected to a second communication network 101 of a second network operator, via a Network to Network Interface (NNI) 102. Both communication networks 100,101 typically comprise a plurality of interconnected network nodes, such as core nodes, access nodes and gateway nodes that have been configured to manage signaling and to provide services to subscribers. For simplicity reasons, only one respective server 103,104, such as e.g. a presence server for providing presence services to authorized subscribers and one respective access node 105,106, are indicated in each one of the communication networks in FIG. 1.

A user A 107, being a subscriber of the first network operator may access communication network 100 via access node 105 in order to get access to services provided by server 103, or to access server 104 via NNI 102, if the network operators of the respective communication networks 100,101 have established an interoperability agreement with each other. In a corresponding way, another user B 108, which is a subscriber of a second network operator, may access server 104, as well as 103, via access node 106.

However, a network operator which offers different options when it comes to subscriptions and services that are available for its own subscribers via its own communication network, does not have any possibility to treat subscribers of another operators communication network in the same way, due to the fact that this other communication network does not have any knowledge about these subscribers, and their agreements with their own network operator.

By way of example, one network operator might have set up different types of service agreements, or contracts, with its subscribers, offering e.g. different levels of usage for the services provided via its communication network. If the network operator has an interoperability agreement with another network operator, this other network operator will not be able to know anything about these different contract types. As a consequence, while a network operator may choose to diversify services, or classify subscribers, e.g. according to different arrangements made up with its own subscribers, a network operator having an interoperating agreement with another network operator, will have to treat all subscription requests received from all subscribers of this other network operator in a uniform manner.

### SUMMARY

It is an object of the present document to address at least some of the problems mentioned above, and more specifically to enable network operators of different communication networks to transfer user specific information between the communication networks in order to enable an interoperability agreement between the two network operators to be valid in both networks.

According to one aspect, a method of managing a subscription request at an originating network node of a first network operator that has established an interoperability agreement with said second network operator is provided, where user context can easily be added to received subscription requests that are originating from, or on behalf of a user being a subscriber of the first network operator. User context that is specifying an agreement between the first network operator and the subscriber is obtained from a memory and added to the subscription request, before the subscription request is transmitted to a terminating network node of the second network operator.

By providing the user context to the terminating network node the second network operator will be able to authorize the subscription request, at least partly on the basis of content of the user context, such that the agreement is applied for the subscriber also by the second network operator.

According to another aspect, a method of authorizing a subscription request originating from, or on behalf of, a user that is a subscriber of a first network operator, at a terminating network node of a second network operator, where the first network operator has established an interoperability agreement with the second network operator, is provided. A subscription request, comprising user context that is specifying an agreement between the first network operator and the subscriber, is received from an originating network node of the first network operator. The user context is stored and by authorizing the subscription request, taking not only the conventional rules, but also the transmitted user context into consideration, the mentioned agreement will be possible to apply for the subscriber also by the second network operator.

According to yet another aspect a method for executing at least one activity associated with a subscription request that has been authorized under consideration of user context, is provided. Such an execution is initiated by the reception of a notify trigger, that is associated with the authorized subscription request. Once received processing of the notify trigger will depend on the content of the user context, in addition to the rules, commonly considered during processing of notify triggers.

User context may be added to a new header, an already existing header, or into the body of a subscription request, and will typically be selected in dependence on the user identity of the subscriber that initiated the subscription request.

The suggested method is suitable for implementation in various types of communication networks, and is also applicable for various kinds of services.

In addition to the suggested method, the claimed invention also refers to an originating network node and a terminating network node, each of which are suitable for executing the suggested method.

### BRIEF DESCRIPTION OF THE DRAWINGS

The accompanying drawings, illustrate exemplified embodiments of the invention, which, together with the description, serve to explain the principles of the invention.

FIG. 1 is a simplified illustration of two interconnected communication networks, according to the prior art.

FIG. 2 is a schematic signaling scheme, illustrating a method of transmitting user context between communication networks, and of using such transmitted context, according to one exemplified embodiment.

FIG. 3 is a simplified schematic illustration of a system architecture, showing how the method suggested with reference to FIG. 3 can be applied for a presence case, according to one exemplified embodiment.

FIG. 4 is a configuration of an originating network node, according to one exemplified embodiment.

FIG. 5 is a configuration of a terminating network node, according to one exemplified embodiment.

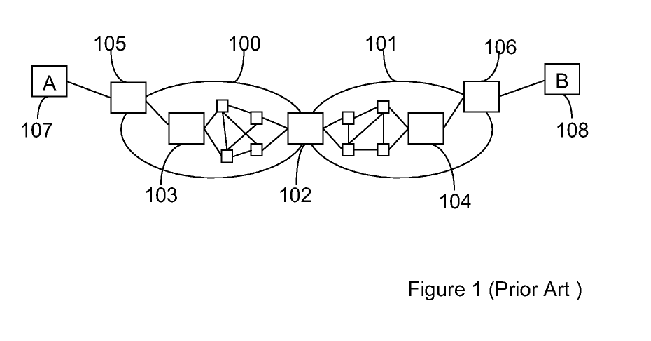

### DETAILED DESCRIPTION

The present document refers to a mechanism that enables a first network operator that has an interoperability agreement with a second network operator, and that classifies its subscribers such that different subscribers may access services via a first communication network of the first network operator under different conditions, to offer the same classification to these subscribers, also when they are accessing the mentioned services via a second communication network of the second network operator.

A subscriber of a network operator always belongs to a specific communication network, via which the network operator of the subscriber offers its services. Such a communication network is typically referred to as the home network of the subscriber.

The general principles for solving the problem mentioned above are based on a modification of a known subscription/notify mechanism, that is applicable in a number of conventional communication networks. The basic idea of the proposed method is to define a way of allowing classification information associated with a subscriber to be transmitted from a communication network of a first network operator, from hereinafter referred to as a first communication network, to a communication network of a second network operator, from hereinafter referred to as a second communication network, and of enabling also the second network operator to use the forwarded classification information in the second communication network, for the purpose of differentiating services when providing these services to subscribers of the first network operator in a similar manner as is done for these subscribers by the first network operator via the first communication network.

The suggested method is based on a modification of the known subscription/notification mechanism that is applicable for different types of services, such as e.g. Presence, and subscriptions for XML document changes, in every situation where the respective service has been invoked by, or on behalf of, a subscriber via a subscription request, and where the requested service is provided to the subscriber as one or more notifications.

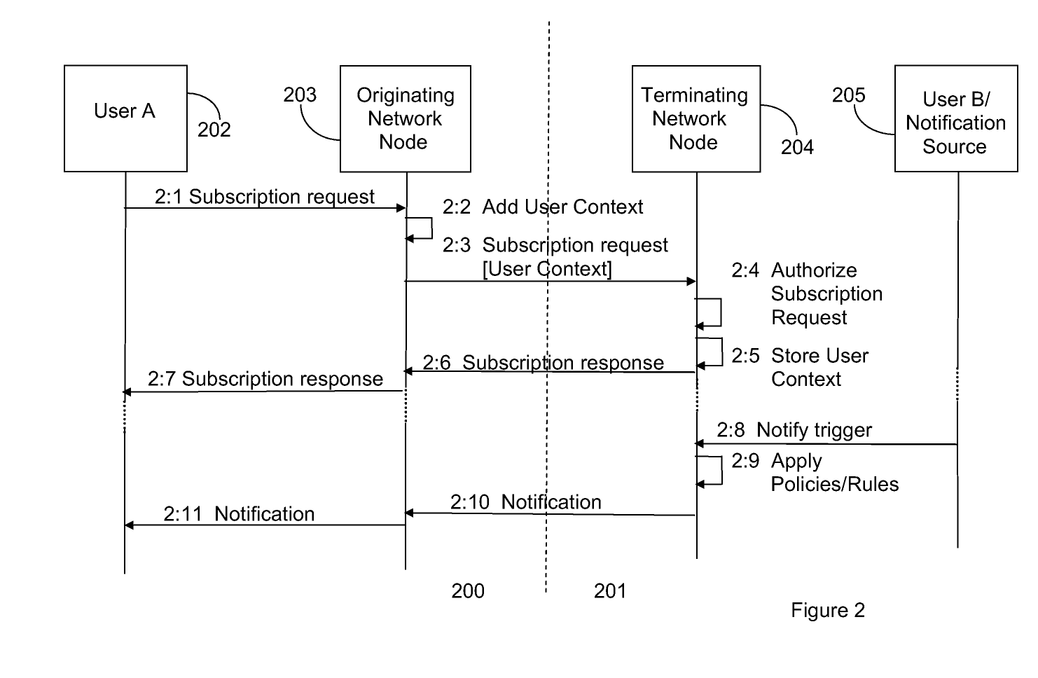

FIG. 2 is a signalling scheme, illustrating the general aspects of the suggested subscription/notification mechanism in more detail, when applied in a first communication network 200, interconnected with a second communication network 201. As already mentioned above it is a prerequisite that the network operator of first communication network 200 has established an interoperability agreement with the network operator, of second communication network 201.

As will be illustrated below with reference to FIG. 2, the suggested, modified subscription/notification mechanism will enable information, from hereinafter referred to as user context, that is associated with the subscriber, to be transferred from the subscribers home communication network to a second communication network via a subscription request. The modified subscription/notification mechanism will also allow the network operator of the second communication network 201, to differentiate service delivery, and to classify subscribers of the first communication network 200, when these subscribers are accessing services via the second communication network 201.

More specifically, user context is provided from the first communication network to a second communication network via a subscription request, where the user context is accessed and used at the second communication network during authorization of the subscription request, in addition to the information conventionally used for authorization purposes. Once a subscription request has been authorized, the user context, which was stored during the authorization procedure, is then also considered by the second communication network, together with the policies and rules that are normally applied each time a notify trigger is to be evaluated for the respective authorized subscription in the second communication network.

At a first step 2:1, a user of the services provided by the network operator of communication network 200, i.e. a subscriber, here referred to as user A 202, having communication network 202, i.e. the first communication network, as its home communication network, that wants to subscribe to a service, transmits a subscription request that has been generated according to conventional procedures via a network node, from hereinafter referred to as an originating network node 203, of the first communication network 200. Such an originating network node may be e.g. any of a Resource List Server (RLS), a Call Session Control Function (CSCF), a Network Session Border Gateway (N-SBG), subscriber device, a SIP client, a Back-to-Back user agent (B2B UA), a SIP proxy, a Resource List Server (RLS), a Watcher Agent, a Call Session Control Function (CSCF) or a Network Session Border Gateway (N-SBG).

In another step 2:2, the originating network node 203 adds user context, that is associated with user A 202 to the subscription request. Typically, all subscription requests forwarded by an originating network node 203, having a communication network node of another communication network as a final destination are provided with user context associated with the respective subscriber, but filtering aspects for selectively determining to which subscription requests to add user context may alternatively be considered.

The subscription request, now comprising the added user context, in addition to the information that is usually provided in a conventional subscription request, is then sent to a terminating network node 204 of the second communication network 201, as indicated with another step 2:3. From hereinafter such a destination network node will be referred to as the terminating network node. Depending on the service requested, the terminating network node may be e.g. a presence server, a presence server, a notifier, a SIP server, a Back-to-Back User Agent (B2B UA), a SIP proxy, or an XML Document Management Server, or any other type of node that is suitable for to handling subscription requests, according to the suggested method.

Once received by the terminating network node 204, the subscription request is handled according to conventional procedures, which may typically comprise a checking of the request against pre-defined authorization rules, as indicated with another step 2:4. However, according to the present method, the terminating network node 204 will be able to use also the user context provided in the subscription request, as input during the authorization procedures, and, on the basis of this additional information, certain differentiations, or classifications, that are normally possible to apply for user A in the first communication network 200 may be applied for user A 202 also in the second communication network 201.

It is to be understood, that, although not explicitly indicated in the figure, additional actions may be taken by the terminating network node, on the basis of the outcome of authorization step 2:4. Such actions are, however out of the scope in this document, and will, for that reason not be discussed in any further detail.

In addition to be used for authorization purposes, the user context obtained in the subscription request is stored in a memory of, or accessible by, the terminating network node 204, as indicated with a next step 2:5. This is to assure that the user context will be accessible, whenever a notify trigger is later received and processed by the terminating network node.

If successfully authorized by the terminating network node 204, the terminating network node 204 verifies this to user A 202, by forwarding a subscription response message, e.g. a 200 OK message, to user A 202, as indicated with step 2:6 and subsequent step 2:7. Alternatively, a subscription response message, indicating that the requested subscription is denied may be provided to user A 202 in response to the subscription request.

Terminating network node 204 is now prepared for providing services that has been classified by the network operator of first communication network 200 to user A 202, according to the authorized subscription, and according to the policies and rules, from hereinafter referred to simply as the rules, that have been predefined and stored at, or accessible to, the terminating network node 204. However, since user context is also accessible to terminating network node 204, this additional information will be considered, not only during authorization, but also whenever a notify trigger, associated with the authorized subscription, requested for in step 2:1, is received from, or on behalf of another user, here referred to as notification source 205.

As indicated with a next step 2:8 of FIG. 2, terminating network node 204 may at any stage receive a notify trigger that is associated with the requested, and approved subscription. If a presence service is applied, such a notify trigger may be e.g. a publish request, that is received from a notification source 205, while an XCAP PUT may be used as notify triggers if instead an updating of XML document changes is applied. In response to such a notify trigger, terminating network node 204 will apply applicable rules, together with the user context that was earlier provided to terminating network node 204 in step 2:3, and stored in step 2:5. Such a procedure is indicated with a subsequent step 2:9.

As a result of step 2:9, a notification is then forwarded to originating network node 203, in a step 2:10, and to user A 202, in a subsequent step 2:11. Additional, subsequent events may be executed according to applicable rules, in response to subsequent notify triggers received at the terminating network node 204, until the respective subscription is terminated according to conventional procedures, such as e.g. a pre-defined time limit for the respective type of subscription.

It is to be understood, that, even though only one terminating network node and one notification source are shown in FIG. 2, a typical scenario may comprise a plurality of terminating network nodes and/or notification sources, that may be located in the same, or in different communication networks. In such a case one subscription request, as indicated with step 2:1, may result in a plurality of subscription requests, as indicated with step 2:3, being sent to one or more terminating network nodes, each subscription request comprising user context, that has been added to the respective subscription requests in repeated steps 2:2. Consequently, a plurality of subscription requests, will result in a plurality or authorization, storing and response steps, as indicated with steps 2:4-2:7.

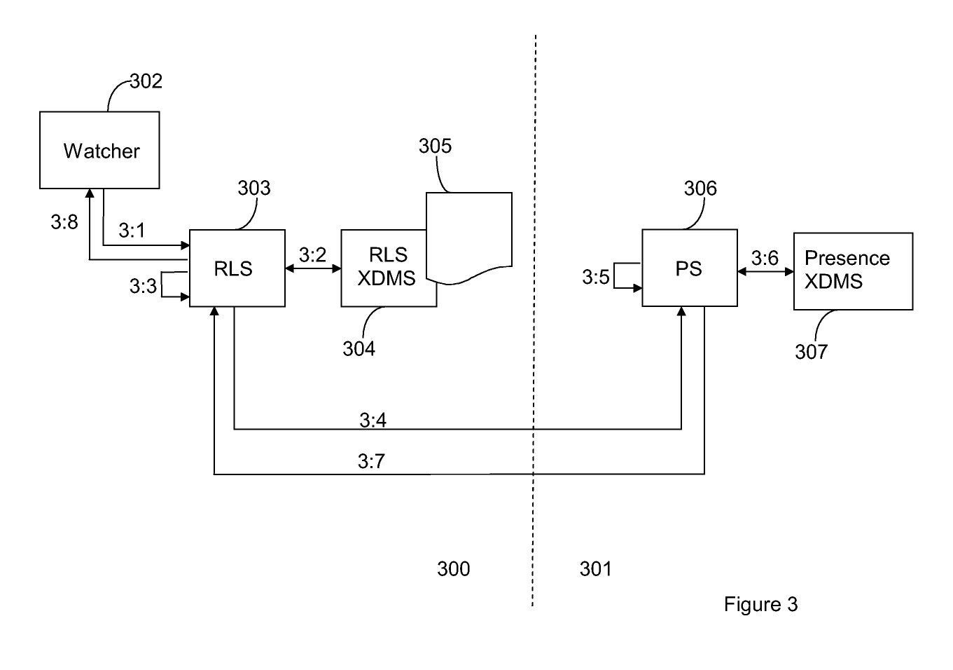

A specific service for which the method described above may be applicable, namely presence service, will now exemplify a typical scenario for execution of an authorization of a requested subscription, with reference to FIG. 3.

In this particular example we assume that a first operator X, managing a first IMS network 300, offers the different subscriptions gold, silver and bronze for its subscribers, where gold subscriptions may provide more exclusive services to its subscribers than silver and bronze subscriptions. In the present example we also assume that, a subscriber, typically referred to as a Watcher 302, has chosen to set up a silver subscription with operator X, and that operator X and another operator Y, managing another IMS network 301, have an interoperability agreement where operator Y e.g. may offer full services to operator X's gold subscribers, while slightly limited services are offered for the silver subscribers, and an even more restricted agreement is applied for the bronze subscribers.

In a first step 3:1, Watcher 302, being an IMS subscriber of Operator X that wants to subscribe to his presence list, sends a subscription request to an RLS 303 of IMS network 300. RLS 303 responds to such a request by invoking an RLS XDMS 304, and by resolving the presence list 305 of Watcher 302. This is indicated with a step 3:2. On the basis of the invoking/resolving step, RLS 303 sends out presence subscription requests to all contacts in the presence list 305. However, prior to transmitting the presence subscription requests, some pre-defined user context, associated with watcher 302, is added to each request. Such a procedure is indicated with a step 3:3 in FIG. 3.

In the present example, the user context may e.g. comprise the information “silver”, that may be added e.g. to a new header that has been introduced to the subscription request. Alternatively, the user context may be added to an already existing header of the subscription request, e.g. as one or more parameters. As a further alternative, the user context may instead be added to the body of the subscription request.

This transmission, that is destined for Presence Server (PS) 306 of IMS network 301, is indicated with a step 3:4 in FIG. 3. As indicated above, a typical scenario may involve the transmission of a plurality of subscription requests to one or more contacts of a presence list. For simplicity reasons, FIG. 3 only illustrates one such transmission.

Once PS 306 has received the subscription request, the user context is stored in a memory, as indicated with a step 3:5, and the subscription request is authorized, not only on the basis of its usual authentication policies/rules, but also considering the user context provided in the subscription request. Such an authorization, which is typically executed by PS 306 by checking its Presence XDMS 307, is indicated with a next step 3:6. The result of this authorization step is transmitted to RLS 303, as indicated with a step 3:7, from where the result is then forwarded to Watcher 302, as indicated with a final step 3:8.

Once a subscription has been set up between the two network operators, Watcher 302 will be able to receive notifications according to the subscription to be applied for the respective service, which in this case is presence, until the subscription is terminated.

By way of example, operator Y might previously have defined a policy that all its silver and bronze subscribers will have a notification rate limitation e.g. of maximum one notification per hour, while all gold subscribers will receive notifications without any rate limitation.

The user context may have been defined as a general user context that is to be applied for a specific type of subscription that a user has set up with an operator, or differentiated on a per service basis for services offered by an operator. In the latter case a gold subscription may e.g. be offered for users requesting for subscriptions associated with presence, while a silver subscription is offered for subscriptions associated with any other type of subscribe/notify service.

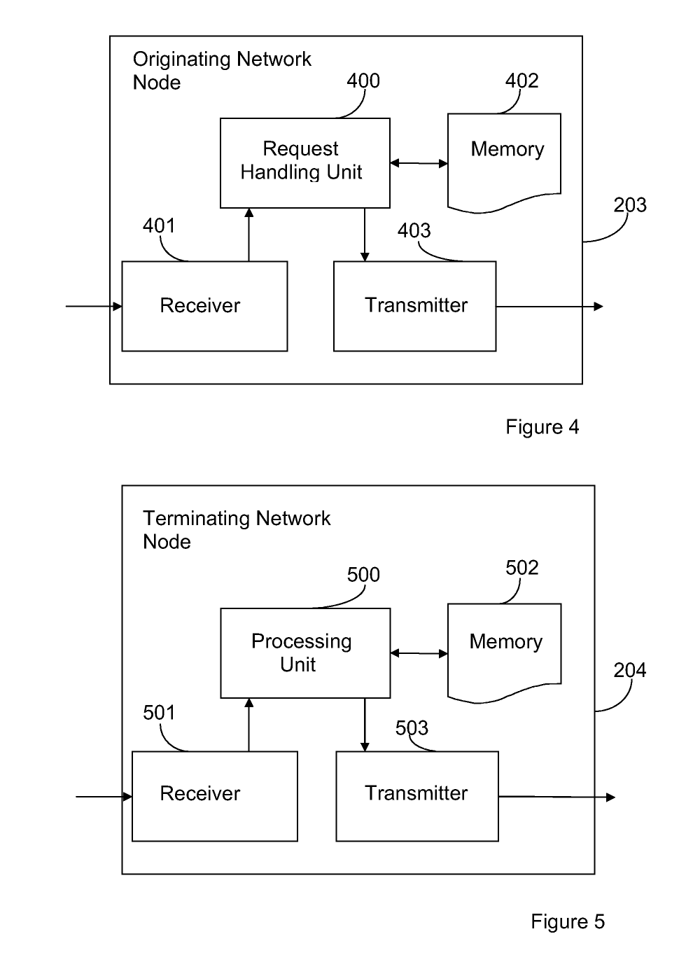

An originating network node 203, may be configured with functional units as exemplified below, with reference to FIG. 4. The originating network node 203 of FIG. 4 comprises a unit, here referred to as a request handling unit 400, that is responsible for adding user context to each subscription requests that are received by the node. The request handling unit 400 is configured to recognise whenever a subscription request, originating from, or on behalf of, a user being a subscriber of a first network operator has been received by a receiver 401 of the originating network node 203. The request handling node 400 is further configured to select user context from a memory 402, and to add the selected user context to the subscription request. The user context, which is specifying an agreement between the respective subscriber and the network operator of the subscriber, and which has been pre-stored in the memory 402, can be selected by the request handling unit 400 on the basis of the user identity of the subscriber. Once user context has been added to a subscription request, the request handling unit 400 is configured to interact with a transmitter 403, such that the subscription request can be transmitted to a terminating network node of a second network operator, as indicated in any of the examples above.

A terminating network node 204 according to one exemplified embodiment will now be described in further detail below, with reference to FIG. 5. The terminating network node 204 of FIG. 5 comprises a unit, referred to as a processing unit 500, that is configured to recognise that that a subscription request of the terminating network node 204 has been received by a receiver 501 of the terminating network node 204. The processing unit 500 is also configured to recognise that the subscription request comprises user context, to store the user context in a memory 502, and to execute an authorization procedure, where the user context is considered in addition to other information that is usually considered during this types of authorization procedures.

The processing unit 500 is also configured to process triggers that are normally used for initiating various activities associated with a service that has originally been initiated by a subscription request. In accordance with a conventional subscription/notification mechanism, the processing unit 500 is configured to apply any type of pre-defined rules, in response to receiving a notify trigger. In addition to considering the pre-defined rules which may be stored in memory 502 or in a separate memory means (not shown), the processing unit 500 is also configured to consider the user context previously stored in memory 502. Depending on the outcome from considering the rules and the user context the processing unit 500 may generate a notification, which it is configured to transmit via a transmitter 503.

It is to be understood that the originating network node, as well as the terminating network node described above, only refer to one alternative way of configuring such respective nodes, that are suitable for executing the methods described above, and that other configurations that enables implementation of the suggested subscription/notification mechanism, i.e. the method steps described in the exemplifications above, will be possible. It is also to be understood that steps, as well as functional units that are normally needed for processing subscription requests and associated notifications in a conventional communications networks, but which are not needed for the understanding of the suggested methods and associated network nodes, have been omitted in this document for simplicity reasons. Such respective method steps and/or functional units may easily be implemented according to any conventional teaching such that they can be used in cooperation with the corresponding method steps and the functional units, referred to in the given examples.

### ABBREVIATIONS

### CSCF Call Session Control Function

### RLS Resource List Server

### NNI Network to Network Interface

N-SBG Network Session Border Gateway

1-22. (canceled)

23. A method of managing a subscription request at an originating network node of a first network operator, said method comprising:
receiving a subscription request originating from, or on behalf of, a user that is a subscriber of said first network operator,
adding, to said subscription request, user context that specifies an agreement between the first network operator and the subscriber, and
transmitting said subscription request to a terminating network node of a second network operator with which said first network operator has established an interoperability agreement, thereby enabling said second network operator to authorize said subscription request at least partly on the basis of content of said user context and to apply said agreement for said subscriber.

24. The method according to claim 23, wherein said user context comprises user specific information that has been pre-defined for said subscriber.

25. The method according to claim 23, wherein said user context comprises user specific information that is valid on a per subscription basis.

26. The method according to claim 23, wherein said user context comprises user specific information that is valid on a per service basis.

27. The method according to claim 26, wherein said subscription request is a request for a presence service, or a subscription for XML document changes.

28. The method according to claim 23, wherein said adding comprises adding said user context to a header of said subscription request.

29. The method according to claim 28, wherein said adding comprises adding said user context to said header as one or more user context parameters.

30. The method according to claim 23, wherein said adding comprises adding said user context to a body of said subscription request.

31. A method implemented by a terminating network node for authorizing a subscription request originating from, or on behalf of, a user that is a subscriber of a first network operator, wherein said first network operator has established an interoperability agreement with a second network operator, wherein said terminating network node is a network node of the second network operator, and wherein the method comprises:
receiving a subscription request from an originating network node of said first network operator, and recognizing, in said subscription request, user context that specifies an agreement between the first network operator and the subscriber,
storing said user context, and
authorizing said subscription request, at least partly on the basis of said user context, such that said agreement is applicable for said subscriber also by said second network operator.

32. The method according to claim 31, wherein said user context comprises user specific information that has been pre-defined for said subscriber.

33. The method according to claim 31, wherein said user context comprises user specific information that is valid on a per subscription basis.

34. The method according to claim 31, wherein said user context comprises user specific information that is valid on a per service basis.

35. The method according to claim 34, wherein said subscription request is a request for a presence service, or a subscription for XML document changes.

36. The method according to claim 31, wherein said user context is included in a header of said subscription request.

37. The method according to claim 36, wherein said user context is included in a header of said subscription request as one or more user context parameters.

38. The method according to claim 31, wherein said user context is included a body of said subscription request.

39. The method according to claim 31, further comprising executing at least one activity associated with the authorized subscription request, by:
receiving a notify trigger associated with said authorized subscription request, and
processing said notify trigger at least partly in dependence on content of said user context.

40. The method according to claim 39, wherein said at least one activity comprises generating and transmitting a notification to said originating network node.

41. An originating network node of a first network operator for managing a subscription request, said originating network node comprising a request handling unit operatively connected to a receiver, a transmitter, and a memory, wherein said request handling unit is configured to:
recognize that said receiver has received a subscription request originating from, or on behalf of, a user that is a subscriber of said first network operator;
add to said subscription request user context that is stored in said memory and that specifies an agreement between the first network operator and said subscriber; and
transmit said subscription request, via said transmitter, to a terminating network node of a second network operator with which the first network operator has an interoperability agreement, thereby making said agreement applicable for said subscriber also by said second network operator.

42. The originating network node according to claim 41, wherein said originating network node is a core network node.

43. The originating network node according to claim 41, wherein said originating network node is any of a subscriber device, a SIP client, a Back-to-Back user agent, a SIP proxy, a Resource List Server, a Watcher Agent, a Call Session Control Function or a Network Session Border Gateway.

44. The originating network node according to claim 41, wherein said request handling unit is configured to add said user context into a header of said subscription request.

45. The originating network node according to claim 44, wherein said request handling unit is configured to add said user context as at least one parameter of a header of said subscription request.

46. The originating network node according to claim 41, wherein said request handling unit is configured to add said user context into a body of said subscription request.

47. The originating network node according to claim 41, wherein said request handling unit is configured to select user context to be added to said subscription request on the basis of a user identity of said subscriber.

48. A terminating network node for authorizing a subscription request originating from, or on behalf of, a user that is a subscriber of a first network operator, wherein said first network operator has established an interoperability agreement with a second network operator, wherein said terminating network node is a network node of the second network operator, and wherein the terminating network node comprises a processing unit operatively connected to a memory and a receiver, wherein said processing unit is configured to:
recognize that said receiver has received a subscription request originating from, or on behalf of, a user that is a subscriber of said first network operator;
recognize, in said subscription request, user context that specifies an agreement between the first network operator and said subscriber, store said user context in said memory, and
execute an authorization procedure that considers said user context as a basis for authorizing said subscription request, thereby making said agreement applicable for said subscriber also by said second network operator.

49. The terminating network node according to claim 48, wherein said terminating network node is any of a presence server, a notifier, a SIP server, a Back-to-Back User Agent, a SIP proxy, or an XML Document Management Server.

50. The terminating network node according to claim 48, wherein said processing unit is further configured to execute at least one activity associated with said authorized subscription request, by:
receiving a notify trigger associated with said authorized subscription request, and
processing said notify trigger at least partly in dependence on content of said user context.

51. The terminating network node according to claim 48, wherein said first and second network operators are operators of a respective IMS network.
